(19) United States
(12) Patent Application Publication
(10) Pub. No.: US 2014/0092328 A1
(43) Pub. Date: Apr. 3, 2014

(54) Electro-Optical Anti-Glare Device Comprising Plano Lenses

(71) Applicants: Rene Werthmuller, Ammerzwil (CH); Livio Ghisleni, Uerikon (CH)

(72) Inventors: Rene Werthmuller, Ammerzwil (CH); Livio Ghisleni, Uerikon (CH)

(73) Assignee: EYEREX AG, Schindellegi (CH)

(21) Appl. No.: 13/982,771

(22) PCT Filed: Dec. 20, 2011
(86) PCT No.: PCT/CH11/00303

§ 371 Date: Dec. 17, 2013

(30) Foreign Application Priority Data
Jan. 31, 2011 (CH) 174/11

(51) Int. Cl. G02F 1/137; G02C 7/10

(52) U.S. Cl. CPC G02F 1/137; G02C 7/10
USPC 349/14

(57) ABSTRACT

Electro-optical glare protection device comprising a liquid crystal (LCD) and an electronic control circuit (75) for controlling same, whereby a plane-parallel liquid crystal cell (LCD) is joint face to have at least on one side with a plane lens (33, 34, 37, 33, 42, 43, 46, 47, 52, 53, 56, 57) in order to form a neutral lens (31, 35) or an ophthalmic lens (41, 45, 51, 55) and in particular a multi-focal or progressive lens. This electro-optical glare protection device is preferably operated in a “normally-black” mode and comprises a wearing-switch (78) which detects whether the anti-glare device is worn or if it is pushed aside or put aside.

The present invention relates to an electro-optical glare protection device in the form of spectacles, a visor, a mask or a helmet according to the preamble of claim 1

Such glare protection devices, particularly sunglasses, have a liquid crystal cell (LCD), the light transmittance (transmissivity or opacity) of which can be altered by means of a suitable electronic control system—as disclosed for example in U.S. Pat. No. 6,501,443 or in EP 2,156,241. The structure of such sun glasses and the liquid crystal cells to be used therefore are well known and described for example in U.S. Pat. No. 4,968,127 and U.S. 5,654,786. Unfortunately, these plano glasses of these sunglasses show to be aesthetically extremely unsatisfactory and are undesirable because of their strong reflections and mirror effects.

In patents U.S. Pat. No. 4,278,474, U.S. Pat. No. 5,067,795 or WO 2009/108753 therefore electro-optical sunglasses are described in which the used liquid crystal cells are slightly curved.

Unfortunately, the production of such built lenses show to be extremely complex and correspondingly expensive. Thus, for example, WO 9,411,779 describes the production of multilayered, curved lens structures from preformed support elements, transparent plastic films, conductive coatings, adhesive layers and spacing layers (spacer) for forming a cavity, which is filled with a suitable liquid crystal material and sealed. In another process for manufacturing such lenses thermoplastic elements are used and the entire stack of layers is hot-formed, as is known for example from EP 1,428,063. This thermoplastically formed lens systems and systems with deformed thin layers generally show interior mechanical stresses which are unacceptable for their ophthalmic use and especially in connection with electro-optical sunglasses. In addition, all of these manufacturing processes require extremely precise and complex equipment, which lead to undesirably high production costs. For the sake of completeness it is pointed out that liquid crystals not only align their dipolar molecules when an electric voltage is applied, but change also their optical density and therewith their refractive index. Moreover, the longer-term operation of curved liquid crystal cells always leads to irreversible damages of the optical properties, because of the occurring molecular separation.

Due to the relatively high power consumption of electro-optical glare protection devices it already has been proposed in WO 2008/148240, to operate these anti-glare devices in the so-called “normally-black” mode for everyday use and for special applications. Therefore the anti-glare device is operated such that it stands or is operated in its darkened state de-energized, in a power reduced or a power saving mode, i.e., with minimal power (“stand-by”-power and in its clear state only an operating current is required. The content of WO 2008/148240 is part of the present description in its full extent and therefore is not further explained. This operating mode has the advantage that the user is not exposed to any flickering effects during harsh environmental conditions and that the power consumption is reducible during long-term use.

Unfortunately it appears that, with the use of this electro-optical glare protection devices its on-/off-switch is not always activated by the here addressed, fashion-conscious users and the glare protection device is often left in a dark environment and in the power-consuming, clear state. This not only leads to undesirably high power consumption, but at the LCDs also to disturbing long-term effects. LCDs must be operated in AC for physical reasons.

There is therefore a need for an electro-optical glare protection device, the appearance of which can be shaped in a simple manner and which is particularly suitable for use in daily life.

In view of the state of the art it is therefore an object of the present invention to provide an electro-optical glare protection device comprising a curved lens that does not have the disadvantages of the known electro-optical glare protection devices, i.e.. does not show any mirror reflections, does not produce any ophthalmic defects, has stable optical properties also for long-term use and is producible in a simple way, i.e.. industrially and economically. In the following the term viewing glass is used for any kind of ophthalmic optics, in particular spectacle lenses, helmet-, mask- or visor-shields for eye protection or as visual aids. In particular, this anti-glare device is to be user-friendly as much as possible, i.e.. is to be energy efficient and flickerfree and is to ensure minimized power consumption.

According to the invention this object is achieved by an electro-optical glare protection device having the features of claim 1. In particular, the anti-glare protection device according to the invention is in the form of spectacles, a visor, a mask or a helmet and comprises at least a viewing glass which is curved at least on one side. This viewing glass has a multilayer structure and comprises at least a plane-parallel liquid crystal cell. On one side of this plane-parallel liquid crystal cell is applied at least a plano-lens, to form a viewing glass with a curved surface. It is understood that the liquid crystal cell can be laminary combined at both sides with curved plano-lenses, in particular with spherical, aspherical, toric, cylindrical, convex or concave plano-lenses in order to form a neutral lens or an ophthalmic lens and particularly to form a multi-focal or progressive lens. Preferably, at least the plane-parallel liquid crystal cell is prefabricated with an outer contour corresponding to an inner contour of a frame or a mount.

In a developed embodiment of the multi-layered visor additional optical elements are provided depending on the application and the customer requirements. For example, the visor set-up according to the invention may comprise at least one polarizing film and/or at least one color filter and/or at least one additional liquid crystal cell—for example, for changing the color scheme and/or for displaying data and information—and/or at least a transparent photocell or a photovoltaic layer and/or at least a low-reflection and/or scratch-resistant coating. In a particular embodiment, the lens includes a Fresnel lens. It is understood that the individual optical elements of the viewing glass may be made of different material, in particular of glass or plastics. A plane-parallel liquid crystal cell of a conventional liquid crystal cell can as well be used, as well as a modern guest-host cell or liquid crystal cells with similarly taking effect.

In a preferred embodiment of the anti-glare device according to the invention the electronic control circuit for changing the transmittance of the viewing glass and/or the switch for activating or disabling the electronic control circuit and/or a regulator for the control of the electronic control circuit is/are at least partially integrated in a frame of the anti-glare device, especially in a spectacle frame and/or in a holder for the anti-glare device, in particular in at least one temple piece. It is understood that the control is operable manually, automatically, sensor-controlled and/or wirelessly. With an associated additional circuit and/or control circuit further electrical functions, for example the control of the detector sensitivity and/or optical functions, e.g. the regulation of the color scheme or 3D-functions of the viewing glasses may be controlled.

To ensure minimized power consumption for the ease of use, the switch to activate or disable the electronic control circuit of the anti-glare device according to the invention is in a preferred embodiment coupled with a wearing-switch—such as described in FR 2,915,815—i.e.. this switch is coupled via an electronic circuitry with an electronic detection device for determining a mode “weared” or “not-weared” of the anti-glare device. This electronic detecting device comprises at least a detector (not shown) for detecting a physiological value of a body region of a wearer, wherein the control electronics are designed such that the electronic control circuit of the anti-glare device is switched on when the mode “weared” is present and the electronic control circuit of the anti-glare device is switched off when the mode “not-weared” is present. Thus, the glare protection according to the invention is controllably switchable on or off.

The value detected by the electronic detection means may be a physical value for an effect exerted by the body region of the wearer onto the detector, such as pressure, tension, torsion or heat or moisture emitted by the body region. In another embodiment of this wearing-switch, the value determined by the electronic detecting means is a contact-free value, i.e.. an inductive, capacitive, acoustic or optical physical value, such as a change of the electromagnetic field caused by the body region at the detector or the spatial location relative to the body region of the wearer or a sound (voice-controlled) or optical (infrared) signal from a remote control. In another embodiment, the detected value from the electronic detection means is a chemical value such as a chemical change caused by the body region at the detector.

In a development of the anti-glare device according to the invention this device is designed such that the electronic control circuit is in a reduced power operational state when the detected mode is “not-weared”, or is in a “stand-by” or in a zero-current operational state.

In a preferred embodiment of the electro-optical glare protection device, the electronic control circuit is designed for a “normally-black”-mode as described in detail in the herewith incorporated WO 2008/148240, where in particular the at least one viewing glass shows in a disabled state a transmittance in the range of 5-10% or less and that in the activated state a transmittance in the range 20-40% or more.

For long-term stability of the elect o-optical glare protection device, the electronic control circuit comprises a flip-flop circuit, by means of which the polarity of the operating voltage applied to the liquid-crystal cell (LCD) is changeable at least when the detected mode is changing, It is understood here that all kinds of liquid crystal cells are meant by the term “liquid crystal cell”, in particular such with active or passive matrix, for example TN-, STN-, DSTN- or TSTN-cells.

In a further developed embodiment of the anti-glare device according to this invention the control electronics is coupled with at least an additional electronic device such as a hearing aid, a radio, a music player, a radiotelephony, a museum guide or audio guide.

The advantages of the viewing glasses set-up in accordance with present invention are immediately apparent to the person skilled in the art and in particular can be seen in the simple manufacture and simple adaptability of the manufacturing process for individual embodiments. For example, the contour of the viewing-glass can be adjusted to the glasses shape and size in a simple manner and in advance of the production of the liquid crystal cells, or in the production of the plano lenses the ophthalmic correction (normal-, short-, farsightedness, strabismus, astigmatism, etc . . . ) can be calculated and varied in a simple manner.

The present anti-glare device in a surprisingly simple manner allows to preventing ophthalmic errors as they occur in curved liquid crystal cells, and also has stable optical properties for long-term use thereof. Moreover, this glare protection device can he produced industrially and economically. In particular, these anti-glare device is operative in energy efficient and flickerfree manner and proves to be user-friendly, i.e.. minimized power consumption of the anti-glare device can be can ensured by the controlled on or off switching.

It is understood that the anti-glare device in accordance with the invention can be used in all types of protective eyewear or helmets, especially sunglasses, so ski goggles, snow and glacier glasses, cyclists or motorist's glasses, race car driver and motorcyclist helmets, diver or aviator glasses, lab safety goggles and all other ophthalmic devices.

In the following, the invention shall be explained in more detail by an exemplary embodiment and with the aid of the figures. In the drawings show;

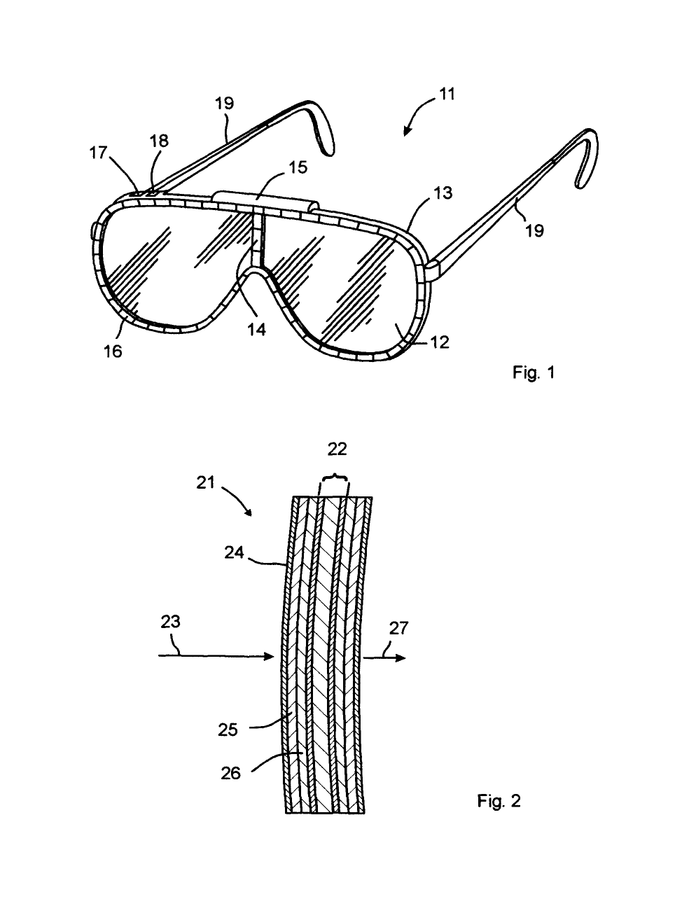

FIG. 1: a perspective view of a known type of sunglasses with a plane set-up of the spectacle lenses;

FIG. 2: a schematic representation of a cross section through a curved set-up of spectacle lenses of known type;

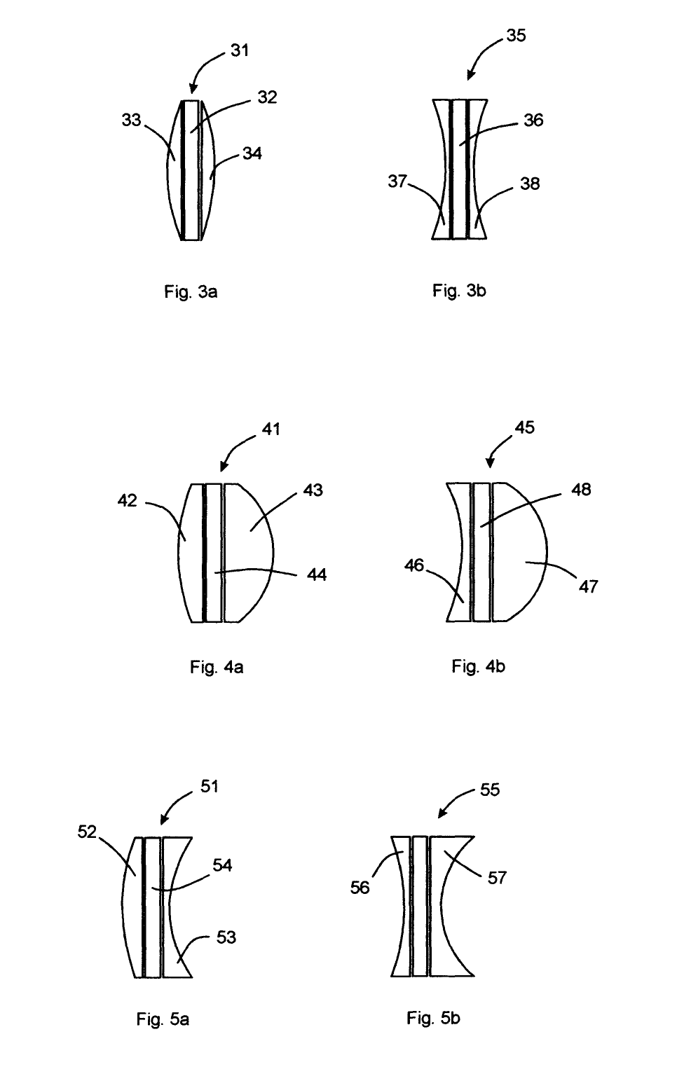

FIG. 3a,b: a schematic representation of a cross section through a lens according to present invention and as a neutral lens;

FIG. 4a,b: a schematic representation of a cross section through a lens according to present invention and as a positive lens;

FIG. 5a,b: a schematic representation of a cross section through an inventive lens as a negative lens;

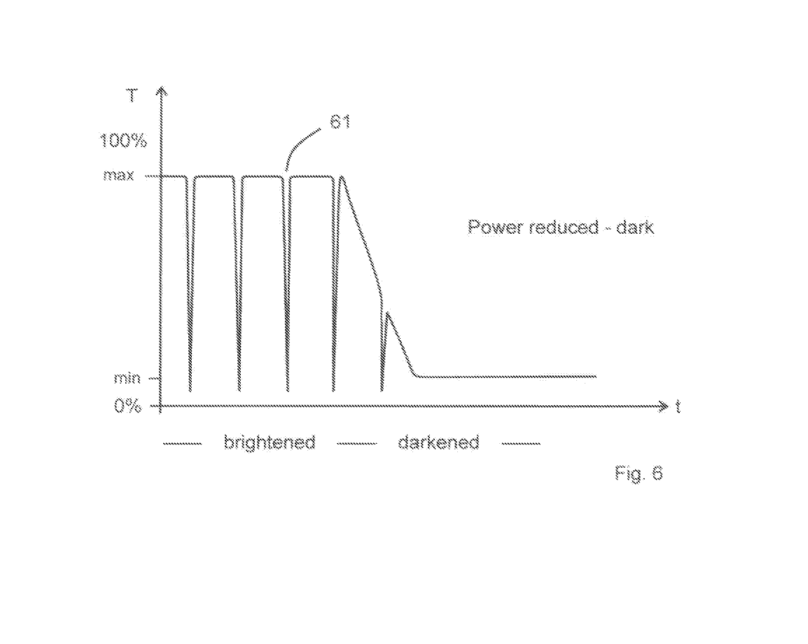

FIG. 6: a schematic diagram of the transmission behavior of a preferred embodiment of the anti-glare device according to the invention;

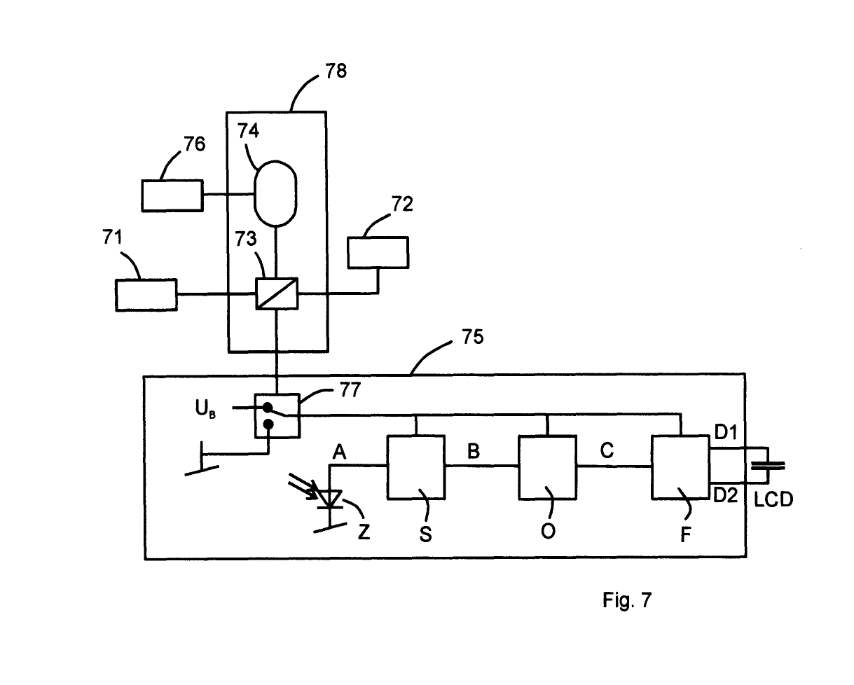

FIG. 7: a schematic circuit diagram of the control circuit of the glare protection device according to the invention.

The known electro-optical sunglasses 11, as shown in FIG. 1, comprise plane spectacle lenses 12 which each have a liquid crystal cell arranged between two plane-parallel glasses and are held in a spectacle frame 13. A photo detector 14 is electronically connected to a control circuit 15 for said liquid crystal cell. Photocells 16 mounted on the spectacle frame 13 provide this control circuit 15 with the necessary energy. With the aid of a switch 17 and a controller 18 the control circuit 15 can be set manually. Depending on the design, a part of the control circuit 15 and/or the power supply can be accommodated into the spectacle temples 19.

In contrast, the sunglass lens assembly 21 shown in FIG. 2 shows a curved liquid crystal cell 22 which is arranged between different optical layers. In this case, an incident light beam 23 first passes through a polarizing film 24, an electrically conductive substrate 25 and a filter layer 26 before it passes through the liquid crystal cell 22. Depending on the applied voltage, the light beam 27 passed through has a higher or lower intensity.

As illustrated in FIG. 3a the viewing glass according to the invention and in the form of a neutral lens 31 comprises a liquid crystal cell 32 which is arranged between two symmetrical plano-convex lenses 33, 34. In contrast the lens as shown in FIG. 3h shows a neutral lens 35 having a liquid crystal cell 36 disposed between two symmetric plano-concave lenses 37, 38.

The structure as shown in FIG. 4a shows a viewing glass designed as a positive lens 41 which comprises two plano-convex lenses 42, 43 with dissimilar radii of curvature. According to the invention these plano-lenses 42, 43 are joint face to face to a liquid crystal cell 44. The structure of a viewing glass designed as a positive lens 45 as shown in FIG. 4b shows a plano-concave lens 46 and a plano-convex lens 47 with dissimilar radii of curvature, which are face to face mounted on a liquid crystal cell 48.

The structure of viewing glass as shown in FIG. 5a is designed in the form of a negative lens 51 and comprises a plano-convex lens 52 and a plano-concave lens 53 with dissimilar radii of curvature, which lenses are joint face to face onto a plane-parallel liquid crystal cell 54. The structure of a viewing glass as shown in FIG. 5b is designed in the form of a negative lens 55 and comprises two plano-concave lenses 56, 57 with dissimilar radii of curvature, which lenses are joint face to face onto a plane-parallel liquid crystal cell.

The diagram in FIG. 6 shows the transmission behavior of an anti-glare device operating according to the invention in a darkened and a lightened state. In a dark environment, that is, in a low light environment, the liquid crystal cell (LCD) is activated and is under voltage. The transmittance of light is in a maximum at these conditions, that is, the anti-glare device is lightened as much as possible. In a bright environment, the electronic control unit turns off the liquid crystal cell (LCD) and the transmittance is a minimum. In the dark, the liquid crystal cell (LCD) is thus activated. The disruptions caused by the AC operation of the activated liquid crystal (LCD) generate at regular intervals blackout moments 61 as they also occur with each blink. Such blackout moments 61 are familiar to the user and cause nor disturbance nor adverse reaction.

FIG. 7 makes clear the operation of the anti-glare device according to the invention and especially of the control electronics 75 with its wearing switch 78. In known manner, a photocell Z (Photo-Diode) produces during a light change of the ambient light from dark to light a first control signal A which is dependent on the brightness and which is fed to a threshold switch S. This threshold switch S generates a control signal B which is supplied to an oscillator O. This oscillator interrupts the generation of vibration signals C which are otherwise supplied to a flip-flop circuit F in order to provide the liquid crystal cell (LCD) with appropriate alternating voltage signals D1 and D2, Due to these interruptions no or no sufficiently high voltage pulses are applied to the liquid crystal cell and causes this cell to drop into its idle state (“normally-black”), i.e., the visor is dark, The power supply of the individual electronic components Z, S, O and F is guaranteed by a DC power source U_{B} with a given output voltage which source can be manually turned on or off by a switch 77. When the environment light changes from light to dark, so a second threshold signal is generated, which signal causes the liquid crystal (LCD) to be activated and to lighten the viewing glass again. In a preferred embodiment of the present invention, the switch 77 is coupled to a wearing switch 78, the links the switch 77 via an electronic circuit 73 to a detector device 74. The electronic detector device 74 detects whether the anti-glare device is worn by the user in a predetermined manner, or is pushed aside by the user or has been set aside. Here this detector device generates control signals for determining a mode “weaved”, or “not-weared”. Therefore the detector device 74 comprises at least a detector (not shown) for determining a physiological value of a body region of a wearer. The value determined by the electronic detector device 74 may be a physical value for an effect exerted by the body region of the wearer onto the detector, such as pressure, tension, torsion or heat or moisture emitted by the body region. The value determined by the electronic detecting device 74 may also be a contact-free value, i.e. an inductive, capacitive, acoustically or optically determined physical value, such as a change of the electromagnetic field caused by the body region onto the detector or the spatial location relative to the body region of the wearer or a sound (voice-controlled) or optical (infrared) signal from a remote control. As well the detected value from the electronic detection device 74 may be a chemical value such as a chemical change caused by the body region onto the detector.

Such detectors are well known to the skilled man and are not part of the present invention. In particular, the switching electronics 73 is designed such that the electronic control circuit 75 of the glare protection device may be switched on when the mode “weared” is present and the electronic control circuit 75 of the glare protection device may be switched off, when the mode “not-weaved” is present. Therewith it allows to controllable switch on or off this glare protection device.

In a particularly preferred embodiment of the anti-glare device, the electronic control circuit 75 is designed such that the device is switched to a reduced power, in a “stand-by” or in a zero-current operational state when in detected mode “not-weared”. It is understood that the electronic control circuit 75 is preferably designed for a “normally-black” mode, and in particular the at least one viewing glass has in a disabled state having a transmittance in the range of 5-15% or less, and in the activated state a transmittance in the range of 15-40% or more.

For long-term stability of the liquid crystal cell LCD, the electronic control circuit 75 includes a flip-flop circuit F with which the polarity of the operating voltage applied to the liquid crystal cell LCD is changeable at least when changing the mode.

It is also understood that the expert adapts the desired lens forms of the viewing glasses in accordance with the needs of the individual user without being inventive. In particular, not only spherical but also aspherical plano-lenses of any type can be used.

The advantages of the viewing glass assembly according to the invention are immediately apparent to the person skilled in the art and in particular are to be seen in the simple manufacture and simple adaptability of the manufacturing process for individual embodiments. For example, the contour of the spectacle lens may be adapted in advance and in a simple manner to a standardized size and shape of spectacles during manufacturing of the liquid crystal cells or the ophthalmic correction may be calculated and varied during the manufacture of the plano-lenses, in a simple manner. It is understood that different applications may be realized with additional devices 72, additional circuitry 71 and/or control circuits 76, in a simple manner, for example, other electrical functions, e.g. the control of the detector sensitivity and/or that optical functions may be provided, for example the control of coloring or 3D functions of the viewing glasses for use as a 3D-spectacles or shooting glasses and that the anti-glare device according to the invention may be equipped with a hearing aid, a radio, a music player, a radiotelephony, a museum guide or audio guide. The viewing glasses in accordance with the invention are suitable for industrial production and at the same time allow easy adaptation to individual needs.

1. Electro-optical glare protection device (11) in form of spectacles, a visor, a mask or a helmet with a viewing glass (12) comprising at least one liquid crystal cell (LCD), and an electronic control circuit (15, 75) for changing the transmittance of the viewing glass (12), said control circuit (15, 75) comprising a switch (17, 77) for activating or disabling the same device, characterized in that the liquid-crystal cell (LCD) is a plane-parallel liquid crystal cell (LCD), which is joint face to face and at least on one side with a curved, in particular spherical, aspheric, toric, cylindrical, convex or concave, plano lens (33, 34, 37, 38, 42, 43, 46, 47, 52, 53, 56, 57) in order to form a neutral or ophthalmic lens and more particularly to form a multi-focal or progressive lens.

2. Electro-optical glare protection device (11) according to claim 1, characterized in that this anti-glare device (11) additional comprises optical elements, such as at least one polarizing sheet, at least one color filter, at least one additional liquid crystal cell to change the color scheme and/or for displaying of data and information, at least a transparent photocell or photovoltaic layer and/or at least a low-reflection and/or scratch-resistant coating.

3. Electro-optical glare protection device (11) according to claim 1, characterized in that the electronic control circuit (15, 75) is at least partially integrated into a frame of the anti-glare device, especially of a spectacle frame and/or into a holder for the anti-glare device, in particular into at least one spectacle temple piece.

4. Electro-optical glare protection device (11) according to claim 1, characterized in that the switch (17, 77) for activating or disabling the electronic control circuit (15, 75) is coupled to a wearing-switch (78), the switch (77) is coupled via an electronic switching system (73) with an electronic detection device (74) for determining a “weared” or “not-weared” mode of the anti-glare device (11), whereby said electronic detection device (74) comprises at least one detector (not shown) for determination of a physiological value of a body region of a wearer, and whereby the electronic circuitry (73) is designed such that the electronic control circuit (15, 75) of the anti-glare device (11) is enabled to be switched on, when the mode “weared” is present and the electronic control circuit (16, 75) of the anti-glare device (11) is enabled to be switched off, when the mode “not-weared” is present.

5. Electro-optical glare protection device (11) according to claim 4, characterized in that the detected value from the electronic detection device (74) is a physical value for an effect exerted by the body region of the wearer onto the detector, such as pressure, tension, torsion or heat or moisture emitted by the body region.

6. Electro-optical glare protection device (11) according to claim 4, characterized in that the detected value from the electronic detection device (74) is a contactless, i.e.. inductively, capacitively, optically or acoustically determined physical value, such as a change of the electromagnetic field caused by the body region onto the detector or the spatial position relative to the body region of the wearer or an acoustic (voice-controlled) signal or an optical (infrared) signal of a remote control.

7. Electro-optical glare protection device (11) according to claim 4, characterized in that the detected value from the electronic detection device (74) is a chemical value, such as a chemical change caused by the body region onto the detector.

8. Electro-optical glare protection device (11) according to claim 4, characterized in that the electronic control circuit (15, 75) of the anti-glare device (11) is present in a reduced power, in a “stand-by” or in a zero-current operational state, in the detected mode “not-weared”.

9. Electro-optical glare protection device (11) according to claim 1, characterized in that the electronic control circuit (15, 75) is designed for a “normally-black” operation whereby in particular the at least one viewing glass (12) has a transmittance in the range from 5-15% or less in the disabled state and has a transmittance in the range of 15-40% or more in the activated state

10. Electro-optical glare protection device (11) according to claim 1, characterized in that the electronic control circuit (15, 75) comprises a flip-flop circuit (F), with which the polarity of the operating voltage applied to the liquid-crystal cell (LCD) is alterable at least when changing the mode.
